(19) United States
(12) Patent Application Publication
(10) Pub. No.: US 2026/0207022 A1
(43) Pub. Date: Jul. 23, 2026

(54) CLEANING ROBOT DOCKING STATION AND CLEANING SYSTEM WITH THE CLEANING ROBOT DOCKING STATION

(71) Applicant: TP-Link Systems Inc., IRVINE, CA (US)

(72) Inventors: Ning CHENG, Shenzhen (CN); Wen LI, Shenzhen (CN); Feixiang MEI, Shenzen (CN); Yuhong HU, Shenzhen (CN); Chunlin XU, Shenzhen (CN)

(73) Assignee: TP-Link Systems Inc., IRVINE, CA (US)

(21) Appl. No.: 19/030,014

(22) Filed: Jan. 17, 2025

(51) Int. Cl. A47L 9/28; A47L 7/00; C02F 11/13

(52) U.S. Cl. CPC A47L 9/2873; A47L 7/0028; A47L 7/0038; C02F 11/13; A47L 2201/028; C02F 2303/06; C02F 2307/12

(57) ABSTRACT

The present disclosure provides a cleaning robot docking station and a cleaning system with a cleaning robot and a cleaning robot docking station. The cleaning robot docking station includes an evaporation apparatus, having an evaporating dish for holding liquid and a heater used to heat the liquid in the evaporating dish to evaporate the liquid; a condensation apparatus, configured to receive a first gas from the evaporation apparatus, condense the water vapor in the first gas, and discharge a second gas. The second gas is heated before being discharged from the cleaning robot docking station or before entering the evaporation apparatus.

### TECHNICAL FIELD

The present disclosure relates to a cleaning robot docking station and a cleaning system with the cleaning robot docking station.

### BACKGROUND

Autonomous cleaning robots have gained widespread adoption across residential homes, offices, and industrial settings for their ability to perform sweeping and/or mopping tasks on various floor surfaces. These robots, commonly known as robotic vacuum cleaners or floor cleaners, are designed to autonomously navigate and clean designated areas before returning to their charging and docking stations. Upon completion of a cleaning cycle, the cleaning robot returns to the docking station, where it transfers the collected dry debris into a dustbin of the docking station and undergoes a cleaning process for its mopping pads.

There is a need for an improved mechanism for handling the wastewater generated from cleaning the mopping pads at the docking station to enhance the user experience.

### SUMMARY

In view of the above problems, the present disclosure provides a cleaning robot docking station and a cleaning robot equipped with the same, which may eliminate the odor of waste gas after condensation without adding extra costs and maintenance steps.

According to an embodiment of the present disclosure, there is provided a cleaning robot docking station, comprising: an evaporation apparatus, having an evaporating dish for holding liquid and a heater used to heat the liquid in the evaporating dish to evaporate the liquid; a condensation apparatus, configured to receive a first gas from the evaporation apparatus, condense the water vapor in the first gas, and discharge a second gas; wherein the second gas is heated before being discharged from the cleaning robot docking station or before entering the evaporation apparatus.

According to another embodiment of the present disclosure, there is provided a cleaning system comprising a cleaning robot and a cleaning robot docking station, the cleaning robot docking station comprises: an evaporation apparatus, having an evaporating dish for holding liquid and a heater used to heat the liquid in the evaporating dish to evaporate the liquid; a condensation apparatus, configured to receive a first gas from the evaporation apparatus, condense the water vapor in the first gas, and discharge a second gas; wherein the second gas is heated before being discharged from the cleaning robot docking station or before entering the evaporation apparatus.

The following text will describe in more detail the preferred embodiment of the invention in this disclosure, in conjunction with the accompanying drawings, so as to easily understand the features and advantages of this disclosure.

### BRIEF DESCRIPTION OF THE DRAWINGS

The above and other objects, features and advantages of the present disclosure will become more apparent by describing embodiments of the present disclosure in more detail in conjunction with accompanying drawings. The drawings are used to provide a further understanding of the embodiments of the present disclosure and constitute a part of the specification. The drawings together with the embodiments of the present disclosure are used to explain the present disclosure, but do not constitute a limitation on the present disclosure. In the drawings, unless otherwise explicitly indicated, the same reference numerals refer to the same components, steps or elements.

FIG. 1 shows a schematic diagram of a cleaning robot docking station according to an embodiment of this disclosure;

FIG. 2 shows a schematic diagram of the waste gas discharge path in the sewage replenishment mode of the cleaning robot docking station according to an embodiment of this disclosure;

FIG. 3 shows a schematic diagram of the waste gas internal circulation path in the water production mode of the cleaning robot docking station according to an embodiment of this disclosure.

### DETAILED DESCRIPTION

The technical solution of the present disclosure will be clearly and completely described below in conjunction with accompanying drawings. Obviously, the described embodiments are part of embodiments of the present disclosure, but not all of them. Based on the embodiments in the present disclosure, all other embodiments obtained by ordinary skilled in the art without making any creative efforts fall within the scope of protection of the present disclosure.

In the description of the present disclosure, it should be noted that orientations or positional relationships indicated by terms such as “center”, “upper”, “lower”, “left”, “right”, “vertical”, “horizontal”, “top”, “bottom”, “internal”, “external”, “inside” and “outside” are based on orientations or positional relationships shown in the drawings, only for the convenience of describing the present disclosure and simplifying the description, instead of indicating or implying the indicated device or element must have a particular orientation. In addition, terms such as “first”, “second” and “third” are only for descriptive purposes, and cannot be understood as indicating or implying relative importance. Likewise, words like “a”, “an” or “the” do not represent a quantity limit, but represent an existence of at least one. Words like “include” or “comprise” mean that an element or an object in front of the said word encompasses those ones listed following the said word and their equivalents, without excluding other elements or objects. Words like “connect” or “link” are not limited to physical or mechanical connections, but may include electrical connections, whether direct or indirect connections.

In the description of the present disclosure, it should be noted that, unless otherwise explicitly specified and limited, terms such as “mount”, “link” and “connect” should be understood in a broad sense. For example, such terms may refer to being fixedly connected, or detachably connected, or integrally connected; may refer to being mechanically connected, or electrically connected; may refer to being directly connected, or indirectly connected via an intermediate medium, or internally connected inside two elements. For ordinary skilled in the art, the meanings of the above terms in the present disclosure may be understood on a case-by-case basis.

In addition, technical features involved in different embodiments of the present disclosure may be combined with each other as long as no conflicts occurs therebetween.

Traditional solutions for docking stations of autonomous cleaning robots, aiming to facilitate user convenience by eliminating the need for clean water replacement and wastewater discharge, have often relied on the installation of complex plumbing systems. These systems automate the process of replenishing clean water and discharging wastewater. However, a significant limitation is the requirement for suitable installation sites with appropriate piping and space, which many households lack, thus preventing the installation of such systems.

Common cleaning robot docking stations on the market often have an integrated clean water tank and a sewage tank. The clean water tank may spray clean water to wash the mop, and the sewage tank stores the sewage generated from washing the mop. Such structures have several issues: first, manual replenishment of clean water and disposal of sewage are required periodically, which is troublesome for users; second, sewage stored in the sewage tank for a long time is prone to odor, and the user experience is poor when cleaning the sewage tank.

There are also cleaning robot docking stations with sewage treatment capabilities, but these generally have odor issues. One type is sewage treatment docking stations without odor control measures, where low-boiling-point odoriferous substances in the sewage evaporate with the water and are eventually discharged into the external environment along with waste gas, and users will smell odors. The other type has odor control measures, such as adding odor control devices or consumables, such as activated carbon or molecular sieves, in front of the waste gas outlet. However, this has the disadvantages of short validity period and increased costs.

To overcome these challenges, the present disclosure proposes an improved solution for docking stations of autonomous cleaning robots that automatically handles wastewater and generates clean water, enabling an effective water recycle.

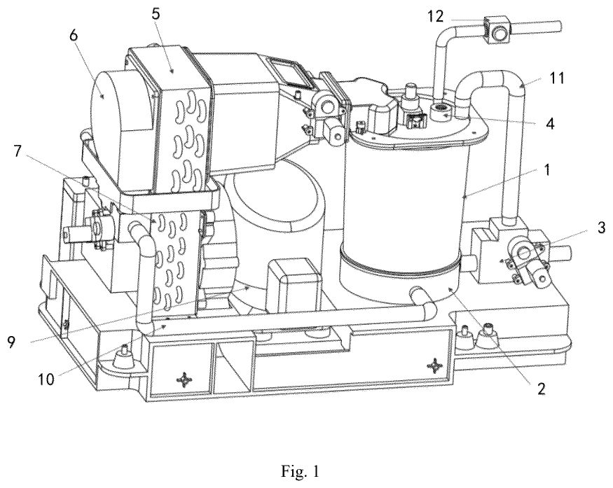

As shown in FIG. 1, according to an embodiment of this disclosure, the cleaning robot docking station is designed to have the ability to autonomously treat wastewater and produce clean water, eliminating the need for manual operations for clean water replacement and wastewater discharge. As shown in FIG. 1, the cleaning robot docking station includes an evaporation apparatus, which has an evaporating dish 1 for holding liquid. The liquid held in the evaporating dish 1 is, for example, wastewater collected from the cleaning robot after the current cleaning cycle and after docking at the cleaning robot docking station. The wastewater in the evaporating dish 1 may be distilled to produce clean water, which may later be stored in the clean water tank (not shown) of the cleaning robot docking station and/or supplied to the cleaning robot for the next cleaning cycle.

In the embodiment shown in the attached figures, the evaporating dish is a roughly cylindrical vessel. However, in embodiments not shown, the evaporating dish may have other structural forms, such as box shape, cube shape, irregular shape, etc.

The evaporation apparatus also has a heater 13. The heater 13 is used to heat the liquid in the evaporating dish 1 to evaporate. The evaporated gas may enter the condensation apparatus of the cleaning robot docking station through a guiding pipe and obtain pure liquid water through condensation.

Understandably, the process of generating clean water through condensation may result in the formation of water droplets. To optimize this process, it is preferable to have a tray or basin in place to collect these purified water droplets initially. This tray serves as an intermediary container where the condensate is first gathered. Once the water in the tray accumulates to a certain level, it may then be pumped into the clean water tank. This approach helps to avoid the frequent and unnecessary activation of the pump, which could lead to undesirable noise.

For the sake of convenience, the gas leaving the evaporation apparatus in this text is referred to as the first gas, which comprises water vapor and will go to the condensation apparatus for condensation to produce pure liquid water. The condensation apparatus receives the first gas from the evaporation apparatus, condenses the water vapor in the first gas, and discharges the remaining gas. The gas discharged from the condensation apparatus in this text is referred to as the second gas.

By the evaporation apparatus, the water content in the sewage from the cleaning robot may be reduced, leading to the concentration of solid waste, which may be retained at the bottom of the evaporation apparatus. Solid waste may be discharged as dry debris through a discharge opening set at the bottom of the evaporation apparatus and collected in a dust bin. Users only need to periodically empty the dry debris in the dust bin, without manually dealing with wastewater.

As mentioned above, there are cleaning robot docking stations with sewage treatment capabilities, but these generally have odor issues. One type is sewage treatment docking stations without odor control measures, where low-boiling-point odoriferous substances in the sewage evaporate with the water and are eventually discharged into the external environment along with waste gas, and users will smell odors. The other type has odor control measures, such as adding odor control devices or consumables, such as activated carbon or molecular sieves, in front of the waste gas outlet. However, this has the disadvantages of short validity period and increased costs.

To eliminate the odor of waste gas without adding extra costs and maintenance steps, this disclosure proposes to heat the second gas with odor discharged from the condensation apparatus. Specifically, according to the different modes of the cleaning robot docking station of this disclosure or the different states of the waste gas valve 3 of the cleaning robot docking station, the second gas may be discharged from the cleaning robot docking station or may enter the evaporation apparatus to form an internal circulation. This disclosure proposes that the second gas is heated before it is discharged from the cleaning robot docking station or before entering the evaporation apparatus. By heating, odor substances may be effectively removed, and the use of chemical treatment agents is reduced, and the costs and maintenance steps are reduced.

Preferably, this disclosure utilizes the heater 13 of the evaporation apparatus to heat the second gas, thereby achieving a deodorizing effect. In this way, the heater 13 of the evaporation apparatus serves a dual role: it is used to heat the wastewater in the evaporating dish 1 to evaporate, and it is also used to heat the second gas to achieve a deodorizing effect. This design may improve energy efficiency and reduce the complexity of the equipment. By using a single heater 13 for multiple functions, energy consumption may be reduced, operating costs may be lowered, and the system design may be simplified, and the maintenance requirements may be reduced. In addition, this integrated solution also helps to make the entire system more compact.

The following text, in conjunction with the accompanying drawings, elaborates on more preferred features of the cleaning robot docking station of this disclosure.

FIG. 1 shows a schematic diagram of a cleaning robot docking station according to an embodiment of this disclosure. As shown in FIG. 1, the cleaning robot docking station includes an evaporation apparatus, which includes an evaporating dish 1 and a heater 13. The heater 13 is provided in the heating chamber 2, and the heating chamber 2 is preferably located directly below the evaporating dish 1. The heater 13 may generate heat when powered to accelerate the evaporation of sewage in the evaporating dish 1. The heater 13 may be embodied as one or more heating tubes. The heating tubes may be coiled in the heating chamber 2. The surface temperature of the heating tubes may be set to reach 1000° C., capable of converting odoriferous gases and organic matter into odorless and harmless substances such as water and carbon dioxide through high-temperature oxidation.

The cleaning robot docking station also includes an exhaust fan 6, which may create a negative pressure to draw the first gas from the evaporation apparatus to the condensation apparatus.

The condensation apparatus of the cleaning robot docking station may be any equipment capable of condensing the water vapor in the first gas. In the embodiment shown in the accompanying drawings, the condensation apparatus is equipped with a refrigerant cycle system. The refrigerant cycle system achieves refrigeration through the coordinated operation of three main components: a compressor 9, an evaporator 5, and a condenser 7. In this refrigerant cycle system, low-pressure and low-temperature refrigerant liquid evaporates in the evaporator 5, absorbing heat from the surrounding environment to lower the temperature of the evaporator 5. The compressor 9, as the power source of the system, may compress the low-pressure refrigerant vapor generated in the evaporator 5 into high-pressure hot vapor, while increasing its temperature and pressure, providing power for the entire cycle. The condenser 7 may release the heat from the high-pressure hot vapor output by the compressor 9, causing it to liquefy.

In the preferred embodiment, the evaporator 5 for the refrigerant serves as the condensation apparatus mentioned above. Since the refrigerant liquid evaporates in the evaporator 5, it provides a low-temperature surface that condenses the water vapor in the first gas due to the cooling effect of this low-temperature surface.

It should be noted that FIG. 1 only illustrates the main components of the docking station and the docking station 100 may incorporate other structures or components not depicted in FIG. 1. In addition, the structures and connections shown in FIG. 1 are exemplary and alternative configurations may also be used. The present disclosure does not limit the details of the structures and their interconnections for the docking station.

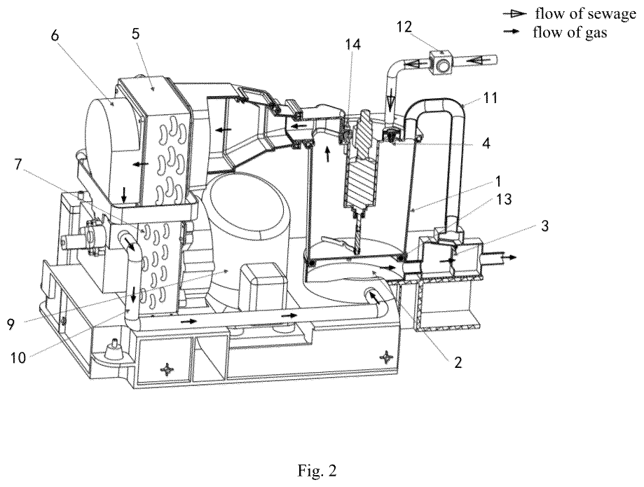

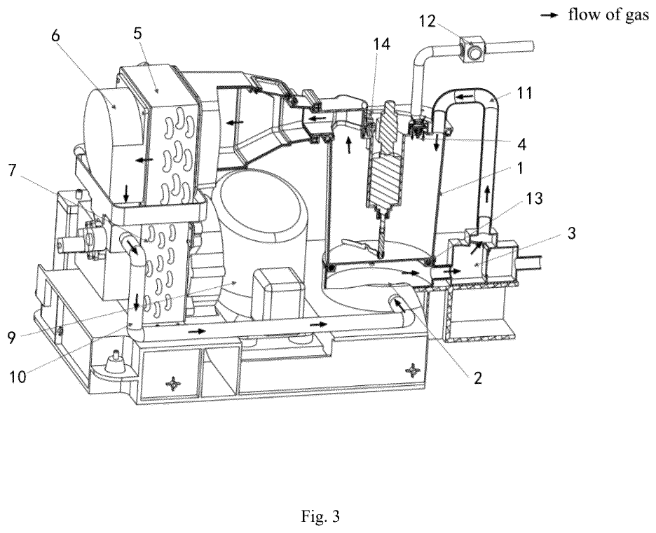

The following text, in conjunction with FIGS. 2 and 3, describes the sewage replenishment mode and water production mode of the cleaning robot docking station of this disclosure. In general, in the sewage replenishment mode, sewage from the cleaning robot is replenished into the evaporating dish 1, and in this mode, the waste gas valve 3 is switched to the first state, allowing the second gas leaving the condensation apparatus to be discharged outside the cleaning robot docking station through the waste gas valve 3. In the water production mode, no sewage is replenished into the evaporating dish 1, and the waste gas valve 3 is switched to the second state, allowing the second gas to enter the evaporation apparatus through the waste gas valve 3 to form a gas internal circulation. The details are as follows.

FIG. 2 shows the sewage replenishment mode, with two types of arrows indicating the flow of sewage and gas. In this mode, the sewage pump 12 is opened to allow sewage to be replenished into the evaporating dish 1 through the sewage inlet, which may be located at the top of the evaporating dish 1.

In this mode, the heater 13 heats the sewage in the evaporating dish 1, and such that the waste gas containing water vapor exist in the evaporating dish 1. Since sewage is replenished into the evaporating dish 1, some of the waste gas in the evaporating dish 1 will be squeezed out and flow towards the evaporator 5 as shown by the solid line arrow. The waste gas from the evaporating dish 1, i.e., the first gas, condenses into liquid water after contacting the low-temperature walls of the evaporator 5. The remaining waste gas, i.e., the second gas, leaves the evaporator 5 and flows forward along the first waste gas channel 10 towards the heating chamber 2 and is heated by the heater 13 to remove odors.] Since the waste gas valve 3 is in the first state at this time, the entrance of the second waste gas channel 11 is closed, and the second gas is discharged outside the cleaning robot docking station through the waste gas valve 3.

In the sewage replenishment mode, the volume of waste gas discharged is approximately equal to the volume of sewage replenished, which is small, and the odors are eliminated at high temperatures. Therefore, the negative impact of the waste gas finally discharged in this mode on the user experience is very low.

As shown in FIG. 2, the cleaning robot docking station has a level sensor 14 to measure the liquid level height in the evaporating dish 1. When the liquid level height reaches or exceeds a threshold, it is considered that enough sewage has been replenished, and the cleaning robot docking station will switch from the sewage replenishment mode to the water production mode. For example, the level sensor 14 with sensor contacts may be installed on the top of the evaporating dish 1. When the liquid level rises and contacts these sensor contacts, it is considered that enough sewage has been replenished and the mode is switched.

FIG. 3 shows the water production mode. Unlike the sewage replenishment mode, in the water production mode, the waste gas valve 3 is set to the second state, in which the second state opens the entrance of the second waste gas channel 11, allowing the second gas to enter the evaporation apparatus through the waste gas valve 3 and the second waste gas channel 11, forming a gas internal circulation. The gas circulation path is indicated by arrows in the figure. The heater 13 heats the sewage in the evaporating dish 1, enriching the gas in the evaporating dish with water vapor. The gas leaving the evaporating dish, i.e., the first gas, flows towards the condensation apparatus (here the evaporator 5) as indicated by the solid line arrow, and condenses into liquid water after contacting the low-temperature wall of the evaporator 5. The gas leaving the condensation apparatus, i.e., the second gas, continues to flow forward along the first waste gas channel 10 towards the heating chamber 2 and is heated by the heater 13 to remove odors, and then enters the second waste gas channel 11 through the waste gas valve 3 in the second state, and then flows into the evaporating dish, forming an internal circulation. The second gas entering the evaporating dish 1 forms a dry convective gas, increasing the evaporation rate. At the same time, the heating of the second gas by the heater 13 may utilize the heat of the heater 13 to achieve deodorization. In this water production mode, no waste gas is discharged, and there is no impact on the user.

Preferably, in the sewage replenishment mode, the heater 13 operates at a first temperature, such as around 200° C. For example, in the sewage replenishment mode, the heater 13 operates at 160° C., 170° C., 180° C., 190° C., 200° C., 210° C., 220° C., 230° C. or the like. In the water production mode, the temperature of the heater 13 is switched to a second temperature, which is higher than the first temperature. Preferably, the second temperature is at or higher than 1000° C., thereby effectively converting odoriferous gases and organic matter into odorless and harmless substances such as water and carbon dioxide through high-temperature oxidation. For example, the second temperature is at or higher than 1050° C., at or higher than 1100° C., at or higher than 1200° C., at or higher than 1300° C. or the like.

As the sewage level in the evaporating dish 1 drops, the environmental pressure inside the system is less than the atmospheric pressure. When the environmental pressure drops to a certain threshold, the check valve 4 above the evaporating dish 1 may be opened by atmospheric pressure, or it may be opened due to the control of a solenoid valve, allowing outside air to enter and preventing a decrease in liquefaction rate caused by the decrease in air pressure.

According to embodiments of the present disclosure, the docking station for a cleaning robot, may comprise a clean water tank configured to store a supply of clean water. In addition, the docking station may further comprise a wastewater tank, which is configured to collect wastewater generated from washing one or more mopping pads of the cleaning robot to be distilled for generating the clean water. As mentioned, the wastewater tank has a discharge opening at its bottom for discharging solidified waste generated from distillation of the wastewater.

According to embodiments of the present disclosure, the docking station may further comprise a waste discharge device having a valve element and a mechanism that may be actuated. The valve element is mounted at a position corresponding to the discharge opening, and it is operable in an open state for uncovering the discharge opening or a closed state for covering the discharge opening. The mechanism may be configured to be actuated while the valve element is in the open state to break through solidified waste formed at the discharge opening. For example, the mechanism may be implemented as a telescopic mechanism movable between a retracted position and an extended position relative to the discharge opening. For example, the valve element may be mounted on an external bottom surface of the wastewater tank, and the telescopic mechanism may be disposed above the discharge opening inside the wastewater tank or disposed below the discharge opening outside the wastewater tank, and movable vertically between the retracted position and the extended position. Accordingly, the telescopic mechanism may be controlled to move from the retracted position to the extended position while the valve element is in the open state to break through the solidified waste formed at the discharge opening of the wastewater tank.

According to embodiments of the present disclosure, the docking station and the cleaning robot may be provided as a complete package in a form of a cleaning system. In the cleaning system, the cleaning robot may perform a cleaning task for the users, such as sweeping and/or mopping tasks on various floor surfaces. Accordingly, the docking station may provide docking functions for the cleaning robot, such as recharging a battery of the cleaning robot, collecting dry debris from the cleaning robot into a dustbin of the docking station and performing a cleaning process for the mopping pads of the cleaning robot. Details of the structure of the cleaning robot is known to those skilled in the art and omitted herein.

The cleaning robot docking station and cleaning robot equipped with the same of this disclosure may eliminate the odor of waste gas after condensation without adding extra costs and maintenance steps.

According to one embodiment of the cleaning robot docking station of the present disclosure, comprising: an evaporation apparatus, having an evaporating dish for holding liquid and a heater used to heat the liquid in the evaporating dish to evaporate the liquid; and a condensation apparatus, configured to receive a first gas from the evaporation apparatus, condense the water vapor in the first gas, and discharge a second gas; wherein the second gas is heated before being discharged from the cleaning robot docking station or before entering the evaporation apparatus.

According to one embodiment of the cleaning robot docking station of the present disclosure, wherein the second gas is heated by the heater of the evaporation apparatus before being discharged from the cleaning robot docking station or before entering the evaporation apparatus.

According to one embodiment of the cleaning robot docking station of the present disclosure, wherein the heater is located in the heating chamber of the evaporation apparatus, and the heating chamber is positioned below the evaporating dish.

According to one embodiment of the cleaning robot docking station of the present disclosure, wherein the heater is one or more heating tube.

According to one embodiment of the cleaning robot docking station of the present disclosure, wherein the sweeping machine docking station has a waste gas valve, the waste gas valve is configured to switch between a first state and a second state, wherein: in the first state, the second gas is discharged through the waste gas valve to the outside of the cleaning robot docking station; in the second state, the second gas enters the evaporation apparatus through the waste gas valve to form a closed loop.

According to one embodiment of the cleaning robot docking station of the present disclosure, wherein the first state corresponds to the sewage replenishment mode of the cleaning robot docking station, wherein sewage is replenished to the evaporating dish in the sewage replenishment mode; and the second state corresponds to the water production mode of the cleaning robot docking station, wherein no sewage is replenished to the evaporating dish in the water production mode.

According to one embodiment of the cleaning robot docking station of the present disclosure, wherein in the first state, the heater operates at a first temperature; in the second state, the heater operates at a second temperature higher than the first temperature.

According to one embodiment of the cleaning robot docking station of the present disclosure, wherein the second temperature is at or higher than 1000° C.

According to one embodiment of the cleaning robot docking station of the present disclosure, wherein the evaporation apparatus has a sewage pump, the sewage pump is configured to pump liquid to the evaporating dish of the evaporation apparatus in the sewage replenishment mode.

According to one embodiment of the cleaning robot docking station of the present disclosure, wherein the cleaning robot docking station has a level sensor to measure the liquid level height in the evaporating dish, wherein when the liquid level height reaches or exceeds a first threshold, the cleaning robot docking station switches from the sewage replenishment mode to the water production mode.

According to one embodiment of the cleaning robot docking station of the present disclosure, wherein the evaporating dish of the evaporation apparatus is equipped with a check valve to allow outside air to enter the evaporating dish.

According to one embodiment of the cleaning robot docking station of the present disclosure, wherein the cleaning robot docking station has an exhaust fan configured to draw the first gas to the condensation apparatus.

According to one embodiment of the cleaning robot docking station of the present disclosure, wherein the condensation apparatus is an evaporator used for refrigerants.

According to one embodiment of the cleaning robot docking station of the present disclosure, wherein the cleaning robot docking station has a first waste gas channel configured to guide the second gas from the condensation apparatus to the heating chamber of the evaporation apparatus.

According to one embodiment of the cleaning robot docking station of the present disclosure, wherein the cleaning robot docking station has a second waste gas channel configured to guide the gas from the waste gas valve to the evaporating dish of the evaporation apparatus.

According to one embodiment of the cleaning system of the present disclosure, the cleaning system comprising: a cleaning robot, and a cleaning robot docking station, the cleaning robot docking station. The cleaning robot docking station, the cleaning robot docking station comprises: an evaporation apparatus, having an evaporating dish for holding liquid and a heater used to heat the liquid in the evaporating dish to evaporate the liquid; a condensation apparatus, configured to receive a first gas from the evaporation apparatus, condense the water vapor in the first gas, and discharge a second gas; wherein the second gas is heated before being discharged from the cleaning robot docking station or before entering the evaporation apparatus.

According to one embodiment of the cleaning system of the present disclosure, wherein the second gas is heated by the heater of the evaporation apparatus before being discharged from the cleaning robot docking station or before entering the evaporation apparatus.

According to one embodiment of the cleaning system of the present disclosure, wherein the sweeping machine docking station has a waste gas valve, the waste gas valve is configured to switch between a first state and a second state, wherein: in the first state, the second gas is discharged through the waste gas valve to the outside of the cleaning robot docking station; in the second state, the second gas enters the evaporation apparatus through the waste gas valve to form a closed loop.

According to one embodiment of the cleaning system of the present disclosure, wherein the first state corresponds to the sewage replenishment mode of the cleaning robot docking station, wherein sewage is replenished to the evaporating dish in the sewage replenishment mode; and the second state corresponds to the water production mode of the cleaning robot docking station, wherein no sewage is replenished to the evaporating dish in the water production mode.

According to one embodiment of the cleaning system of the present disclosure, wherein in the first state, the heater operates at a first temperature; in the second state, the heater operates at a second temperature higher than the first temperature.

Expression such as “according to”, “based on”, “dependent on”, and so on as used in the disclosure does not mean “according only to”, “based only on”, or “dependent only on”, unless it is explicitly otherwise stated. In other words, such expression generally means “according at least to”, “based at least on”, or “dependent at least on” in the disclosure.

Any reference in the disclosure to an element using the designation “first”, “second” and so forth is not intended to comprehensively limit the number or order of such elements. These expressions may be used in the disclosure as a convenient method for distinguishing two or more units. Thus, a reference to a first unit and a second unit does not imply that only two units may be employed or that the first unit must precede the second unit in some form.

The term “determining” used in the disclosure may include various operations. For example, regarding “determining”, calculating, computing, processing, deriving, investigating, looking up (e.g., looking up in tables, databases, or other data structure), ascertaining, and so forth are regarded as “determination”. In addition, regarding “determining”, receiving (for example, receiving information), transmitting (for example, transmitting information), input, output, accessing (for example, access to data in the memory), and so forth, are also regarded as “determining”. In addition, regarding “determining”, resolving, selecting, choosing, establishing, comparing, and so forth may also be regarded as “determining”. That is, regarding “determining”, several actions may be regarded as “determining”.

The terms such as “connected”, “coupled” or any of their variants used in the disclosure refer to any connection or combination, direct or indirect, between two or more units, which may include the following situations: between two units that are “connected” or “coupled” with each other, there are one or more intermediate units. The coupling or connection between the units may be physical or logical, or may also be a combination of the two. As used in the disclosure, two units may be considered to be electrically connected through the use of one or more wires, cables, and/or printed, and as a number of non-limiting and non-exhaustive examples, and are “connected” or “coupled” with each other through the use of electromagnetic energy with wavelengths in a radio frequency region, the microwave region, and/or in the light (both visible and invisible) region, and so forth.

When used in the disclosure or the claims ‘including”, “comprising”, and variations thereof, these terms are as open-ended as the term “having”. Further, the term “or” used in the disclosure or in the claims is not an exclusive-or.

The present disclosure has been described in detail above, but it is obvious to those skilled in the art that the present disclosure is not limited to the embodiments described in the disclosure. The present disclosure may be implemented as a modified and changed form without departing from the spirit and scope of the present disclosure defined by the description of the claims. Therefore, the description in the disclosure is for illustration and does not have any limiting meaning to the present disclosure.

What is claimed is:

1. A cleaning robot docking station, comprising:
an evaporation apparatus, having an evaporating dish for holding liquid and a heater used to heat the liquid in the evaporating dish to evaporate the liquid;
a condensation apparatus, configured to receive a first gas from the evaporation apparatus, condense the water vapor in the first gas, and discharge a second gas;
wherein the second gas is heated before being discharged from the cleaning robot docking station or before entering the evaporation apparatus.

2. The cleaning robot docking station according to claim 1, wherein the second gas is heated by the heater of the evaporation apparatus before being discharged from the cleaning robot docking station or before entering the evaporation apparatus.

3. The cleaning robot docking station according to claim 1, wherein the heater is located in the heating chamber of the evaporation apparatus, and the heating chamber is positioned below the evaporating dish.

4. The cleaning robot docking station according to claim 1, wherein the heater is one or more heating tube.

5. The cleaning robot docking station according to claim 1, wherein the sweeping machine docking station has a waste gas valve, the waste gas valve is configured to switch between a first state and a second state, wherein:
in the first state, the second gas is discharged through the waste gas valve to the outside of the cleaning robot docking station;
in the second state, the second gas enters the evaporation apparatus through the waste gas valve to form a closed loop.

6. The cleaning robot docking station according to claim 5, wherein
the first state corresponds to the sewage replenishment mode of the cleaning robot docking station, wherein sewage is replenished to the evaporating dish in the sewage replenishment mode; and
the second state corresponds to the water production mode of the cleaning robot docking station, wherein no sewage is replenished to the evaporating dish in the water production mode.

7. The cleaning robot docking station according to claim 5, wherein
in the first state, the heater operates at a first temperature;
in the second state, the heater operates at a second temperature higher than the first temperature.

8. The cleaning robot docking station according to claim 7, wherein the second temperature is at or higher than 1000° C.

9. The cleaning robot docking station according to claim 6, wherein the evaporation apparatus has a sewage pump, the sewage pump is configured to pump liquid to the evaporating dish of the evaporation apparatus in the sewage replenishment mode.

10. The cleaning robot docking station according to claim 6, wherein the cleaning robot docking station has a level sensor to measure the liquid level height in the evaporating dish, wherein when the liquid level height reaches or exceeds a first threshold, the cleaning robot docking station switches from the sewage replenishment mode to the water production mode.

11. The cleaning robot docking station according to claim 1, wherein the evaporating dish of the evaporation apparatus is equipped with a check valve to allow outside air to enter the evaporating dish.

12. The cleaning robot docking station according to claim 1, wherein the cleaning robot docking station has an exhaust fan configured to draw the first gas to the condensation apparatus.

13. The cleaning robot docking station according to claim 1, wherein the condensation apparatus is an evaporator used for refrigerants.

14. The cleaning robot docking station according to claim 3, wherein the cleaning robot docking station has a first waste gas channel configured to guide the second gas from the condensation apparatus to the heating chamber of the evaporation apparatus.

15. The cleaning robot docking station according to claim 1, wherein the cleaning robot docking station has a second waste gas channel configured to guide the gas from the waste gas valve to the evaporating dish of the evaporation apparatus.

16. A cleaning system, comprising:
a cleaning robot, and
a cleaning robot docking station, the cleaning robot docking station comprises:
an evaporation apparatus, having an evaporating dish for holding liquid and a heater used to heat the liquid in the evaporating dish to evaporate the liquid;
a condensation apparatus, configured to receive a first gas from the evaporation apparatus, condense the water vapor in the first gas, and discharge a second gas;
wherein the second gas is heated before being discharged from the cleaning robot docking station or before entering the evaporation apparatus.

17. The cleaning system according to claim 16, wherein the second gas is heated by the heater of the evaporation apparatus before being discharged from the cleaning robot docking station or before entering the evaporation apparatus.

18. The cleaning system according to claim 16, wherein the sweeping machine docking station has a waste gas valve, the waste gas valve is configured to switch between a first state and a second state, wherein:
in the first state, the second gas is discharged through the waste gas valve to the outside of the cleaning robot docking station;
in the second state, the second gas enters the evaporation apparatus through the waste gas valve to form a closed loop.

19. The cleaning system according to claim 18, wherein
the first state corresponds to the sewage replenishment mode of the cleaning robot docking station, wherein sewage is replenished to the evaporating dish in the sewage replenishment mode; and
the second state corresponds to the water production mode of the cleaning robot docking station, wherein no sewage is replenished to the evaporating dish in the water production mode.

20. The cleaning system according to claim 18, wherein
in the first state, the heater operates at a first temperature;
in the second state, the heater operates at a second temperature higher than the first temperature.
